(19) United States
(12) Patent Application Publication
(10) Pub. No.: US 2023/0185767 A1
(43) Pub. Date: Jun. 15, 2023

(54) VALIDITY MANAGEMENT SYSTEM FOR DIGITAL FILE AND METHOD FOR OPERATING THE SAME

(71) Applicant: National Applied Research Laboratories, Taipei City (TW)

(72) Inventors: CHIA-HSIEN HUNG, Taichung City (TW); JEN-WEI HU, Tainan City (TW); LO-YAO YEH, Taichung City (TW)

(21) Appl. No.: 17/953,409

(22) Filed: Sep. 27, 2022

(30) Foreign Application Priority Data
Dec. 13, 2021 (TW) 110146479

(51) Int. Cl. G06F 16/14; H04L 9/00; H04L 9/08

(52) U.S. Cl. CPC G06F 16/152; H04L 9/50; H04L 9/0822

(57) ABSTRACT

A validity management system for a digital file and a method for operating the same are provided. The system includes a file server that is connected with a file storage system and a blockchain for providing services of file preservation, verification and setting time validity. When an original file is received, an identification data is created and a hash value is calculated. The original file is uploaded to the file storage system that provides an original file address. The hash value, the identification data and the original file address are transmitted to the blockchain for creating a record. When any user requests for retrieving the original file, the original file is retrieved from the file storage system, and can be verified according to the record obtained from the blockchain. Afterwards, the user creates a copied file and decides accessibility of the copied file by setting time validity.

### CROSS-REFERENCE TO RELATED PATENT APPLICATION

This application claims the benefit of priority to Taiwan Patent Application No. 110146479, filed on Dec. 13, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure is related to a validity management method for a file, and more particularly, to the validity management system that utilizes a blockchain technology to verify time validity of a digital file and a method for operating the validity management system.

### BACKGROUND OF THE DISCLOSURE

A blockchain is able to provide immutable verification data specified to a file or any information. Therefore, the immutable verification data is often used in applications verifying validity of information, e.g., verifying a certificate such as a graduation certificate and a professional certification, or verifying supply chain information.

For providing validity of information, personal information that is often used to prove a validity gradually becomes more difficult to be used to verify validity of information because personal information protection becomes more and more rigorous for individuals and governments, which can be exemplified by the implementation of the General Data Protection Regulation (GDPR). One of the solutions for verifying the validity of information is to use the blockchain to record the verifiable information. For example, the verifiable information can be a link address (e.g., a URL) of a specific file, or a code (e.g., a QR code) of specific information recorded in the blockchain.

However, in the solution using the blockchain, the immutability of blockchain is also a shortcoming since it is almost impossible to delete the data recorded in the blockchain, so that the solution lacks flexibility. Therefore, the features of blockchain also limit applications of the blockchain. Further, it is difficult to limit users and time at which the data recorded in the blockchain may be retrieved, since the data is open to public through the blockchain.

### SUMMARY OF THE DISCLOSURE

In response to the above-referenced technical inadequacies in the conventional technology and a need for file verification, the present disclosure provides a validity management system for a digital file and a method for operating the validity management system, especially for a technical purpose of setting time validity for the digital file.

In an aspect of the present disclosure, the validity management system for a digital file is provided. The validity management system includes a file server that provides services of file preservation, verification, and time validity setting. The file server is connected with a file storage system and a blockchain. In the file server, a file provider provides an original file, an identification data with respect to the original file (i.e., an original file ID) is created, and an original file hash value is calculated. The original file is then encrypted and uploaded to the file storage system, and then an original file address is received from the file storage system. Thus, the file server uploads the original file hash value, the original file ID and the original file address to the blockchain, so as to form a record in the blockchain.

When the validity management system is in operation, for setting time validity for the digital file, the validity management system receives the original file ID, which is originally provided by the file provider and submitted by a user, the file server then verifies identity and permission of the user, queries the database for retrieving the original file address, and retrieves the original file from the file storage system according to the original file address.

At this time, the file server retrieves the record corresponding to the original file from the blockchain according to the original file ID. The original file can be verified by comparing the original file hash value with the record obtained from the blockchain. When the original file is verified, the system allows the user to produce a copied file that is a copy of the original file, generate a key, and create a copied file ID. The user can therefore set a time validity data for the copied file and encrypt the copied file by using the key to add the time validity data into the copied file. The encrypted copied file is then uploaded to the file storage system. After obtaining a copied file address, the user can obtain the key and/or the copied file ID from the file storage system, and the user can share the file with another user that is a file user.

Preferably, the time validity data configured by the user in the file server can be written to a header or a metadata of the copied file.

Preferably, the file server can retrieve the copied file from the file storage system periodically or according to an instruction, and determines whether or not to provide the copied file according to the time validity data in the header or in the metadata. The time validity data indicates a valid time or one or more times available for accessing the copied file.

Still further, for the user sharing the copied file with the time validity data with the file user, the file server firstly receives a request submitted by the file user for obtaining the copied file, and the request includes the key and/or the copied file ID. After querying the database, the copied file address can be retrieved. The encrypted copied file is retrieved from the file storage system according to the copied file address. Afterwards, the copied file can be decrypted by using the key.

The file server then checks the valid time of the copied file and determines if the copied file is valid according to the time validity data of the copied file. A copied file hash value is calculated if the copied file is valid. The record corresponding to the original file is retrieved from the blockchain, and the copied file can be verified by comparing the copied file hash value with the hash value recorded in the record. If the copied file is verified, the copied file can be provided to the file user.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting a network framework of a validity management system according to one embodiment of the present disclosure;

FIG. 2 is a schematic diagram depicting functional modules of the validity management system according to one embodiment of the present disclosure;

FIG. 3 is a flowchart illustrating the validity management system performing file preservation in one embodiment of the present disclosure;

FIG. 4 is a flowchart illustrating the validity management system providing a digital file and setting time validity in one embodiment of the present disclosure;

FIG. 5 is a flowchart illustrating the validity management system verifying time validity of a file and enabling a third party to retrieve the file according to one embodiment of the present disclosure;

FIG. 6 is one further flowchart illustrating the validity management system verifying time validity of a file in one further embodiment of the present disclosure; and

FIG. 7 is a flowchart illustrating a method for operating the validity management system according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure relates to a validity management system for a digital file and a method for operating the validity management system for a digital file. The validity management system implements a file service through a computer system. One of the objectives of the validity management system is to preserve files by using a specific file storage system, and adopt a blockchain to preserve records for verifying accuracy and immutability of the files. The validity management system can guarantee accuracy of each of the file through a rigorous verification process and allow a user to set a valid time for accessing the file when the file is delivered among multiple users.

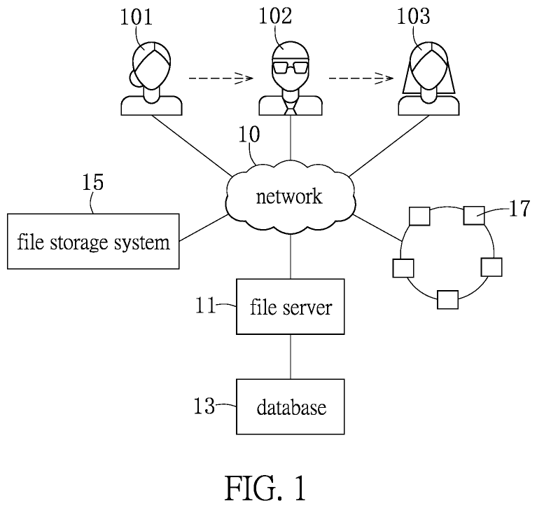

Reference is made to FIG. 1, which is a schematic diagram depicting a network framework of a validity management system according to one embodiment of the present disclosure. The validity management system mainly provides a file server 11 that can be connected with a file storage system 15 and a blockchain 17. According to one of the embodiments of the present disclosure, the file server 11 is connected with the file storage system 15 via a file storage system interface (not shown in the diagram). The file storage system interface can be implemented by a collaboration of hardware and software. The file server 11 stores files into the file storage system 15 and obtains file addresses of the files. The file server 11 also implements a blockchain interface (not shown in the diagram) by a collaboration of hardware and software for connecting with the blockchain 17. The file server 11 transmits a file address, file information, and file identification data (i.e., file ID) to the blockchain 17 via the blockchain interface, so as to form a record in the blockchain.

One of the objectives of the file server 11 is to provide services of file preservation, verification, and time validity setting. The file server 11 includes a database 13 that stores various file information, and specifically preserves the digital files uploaded by users. The file server 11 also stores the file information and the file ID that are established in the validity management system for the digital file. The file server 11 provides a user interface that allows multiple users to access the file. As shown in the diagram, a user A (101), a user B (102), and a user C (103) can set time validity data for the digital file via the user interface. The time validity data is such as a valid time.

According to an exemplary example of the present disclosure, the user A (101) acts as a file provider that uploads a file to a file storage system 15 via the file server 11 and stores the information that is used to identify the file and to verify accuracy of the file to a blockchain 17. A database 13 is used to store information such a file owner, a file address, and/or identification data of the file. The user B (102) acts as a file owner. When the user A (101) uploads the file to the file storage system 15 via the file server 11, the user B (102) is set to be the file owner and the user B (102) becomes a user having full permission to access the file. The user B (102) can also produce a copy of the file via the file server 11, and set a time validity for the copied file. Therefore, any user, such as the user C (103), is authorized to access the copied file within a period of a valid time. The user C (103) transmits a request for accessing a file to the file server 11 based on the information provided by the user B (102). The information submitted by the user C (103) is such as a key for encrypting the file and the file ID of the file. The file server 11 queries a copied file address according to the information submitted by the user C (103). The copied file can be retrieved from the file storage system 15 according to the copied file address. Afterwards, the validity of the copied file can be checked based on the time validity set by the user B (102). The user C (103) acquires the copied file if the copied file is verified to be valid.

According to one embodiment of the present disclosure, the file storage system 15 can be a distributed file system (DFS). The DFS implements a network file system that relies on a distributed algorithm to store a file into multiple nodes in a distributed manner. Each of the nodes is a computer device that shares its storage space and computing resource. Afterwards, the user can retrieve the file by reassembling the data from the nodes according to index information in each of the nodes or a hash table that is established when the file is stored in the distributed manner. The distributed file system is such as an interplanetary file system (IPFS) that divides the file and stores the divided file in a distributed manner through a network transmission protocol that regulates distributed storage and file sharing.

The blockchain 17 is a technology for storing data in a sequence of time and forming a list of blocks. Each block contains a hash, a time stamp, and a transaction record of its previous block. The data cannot be altered once written into the blockchain. The data can be recorded into multiple nodes of the blockchain through a distributed algorithm A consensus algorithm is required for block verification, so that immutability of records stored in the blockchain can be guaranteed. Accordingly, the consensus algorithm can be used to verify accuracy of the data.

According to one embodiment of the present disclosure, the user interface provided by the file server 11 can be a web page, or a software interface initiated by a specific application. The file server 11 allows the user to log on and set time validity for a file. Software services operated in the file server 11 include verifying a user identity when the user logs on the file server 11, encrypting the file, performing a hash algorithm on the file, deciding a time to delete the file according to the valid time, and checking validity of the file based on a request for accessing the file. The file can be provided to the user if the validity of the file is verified. The file storage system is preferably a distributed cloud storage system.

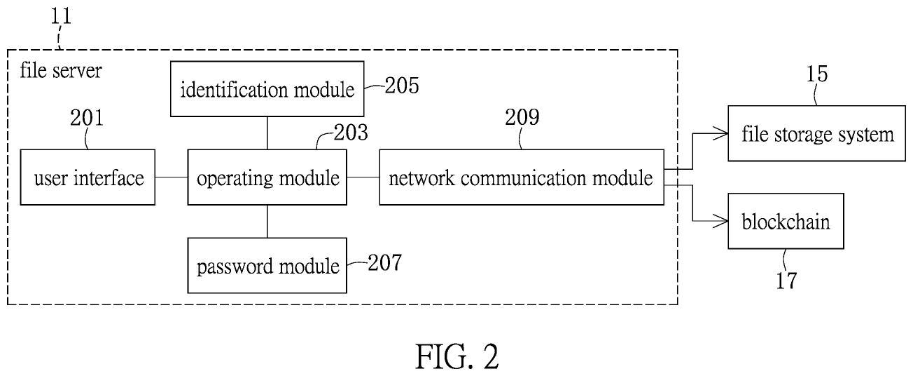

FIG. 2 is a schematic diagram depicting functional modules of the validity management system according to one embodiment of the present disclosure. This diagram exemplarily shows various functional modules implemented by collaboration of software and hardware based on their functions.

The file server 11 that is connected with the file storage system 15 and the blockchain 17 provides a user interface 201 for users to remotely access the file server 11 via a network. According to one of the embodiments of the present disclosure, the file server 11 enables a web server that allows a user to log on the file server 11 via a web interface so that the user can submit a request for accessing a database via the web interface.

The file server 11 includes an operating module 203 that is used to operate the file server 11 for the user to upload files. After the files are processed by the operating module 203, relevant data of the files can be stored to the file storage system 15 and the blockchain 17. The file server 11 respectively connects with the file storage system 15 and the blockchain 17 via two interfaces through a network communication module 209. The operating module 203 provides an operating interface for the user to set time validity. An identity identification module 205 of the file server 11 is used to verify identity and permission of a user that logs on. A password module 207 of the file server 11 is a software module used to generate a key, and encrypt and decrypt a file. The password module 207 is also used to calculate a hash value and perform digital signature for the file. The network communication module 209 to provides an external connection for the file server 11 and processes network packets.

The objective of the above-mentioned file server of the validity management system can be divided into three phases. In a first phase, the user A (i.e., the user A (101) of FIG. 1) is a file provider that provides an original file. The file server establishes information relevant to the original file and calculates a value (e.g. a hash value) for verifying accuracy of the file. The original file is encrypted and uploaded to the file storage system. After acquiring an original file address, the information such as an original file hash value, an original file ID, and the original file address is then uploaded to the blockchain so as to form a record therein.

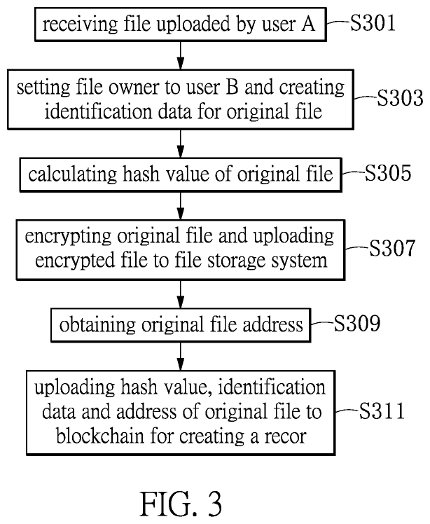

A process illustrating the first phase can be referred to in the flowchart as shown in FIG. 3 that describes a process of saving a file in the validity management system. The user A can be the file provider that is a unit which issues a certificate, such as a school that provides a diploma to a student, a private unit or a government department that issues a license, or an organization that issues a product traceability document.

The file server of the validity management system receives an original file uploaded by the user A (step S301), and the file is such as an image or a textual file of the certificate, the license, or the traceability document, however, the practical application of the present disclosure is not limited to the abovementioned file. The file server provides a user interface for the user A to set information relevant to the file. The information may be associated to a file owner, i.e., the user B. The user A can set an authentication data such as an account and a password for the user B to log on the file server. An original file ID that is used to identify the original file is then established (step S303). For example, the system can set a unique file ID, or the unique file ID can be set by the user A. The system relies on the unique file ID to establish a correlation lookup table or a database index for a correlation between the original file and the original file ID.

At this time or any time from the current point in time, the file server calculates an original hash value for the original file through a hash algorithm (step S305). A file processing program corresponding to the file storage system encrypts the original file and uploads the encrypted original file to the file storage system (step S307). The file storage system can be a cloud storage system or a distributed storage system. For the distributed storage system, such as an IPFS, the original file can be uploaded to multiple nodes of the distributed storage system when a corresponding distributed algorithm is performed on the file. After the original file is uploaded, an original file address used for retrieving the original file can be obtained from the file storage system (step S309).

If a processing procedure in the file server retrieves the original file hash value, the original file ID and the original file address, an encryption algorithm specified to a specific blockchain is used to encrypt these data. The encrypted data is then uploaded to the blockchain and forms records in multiple nodes of the blockchain (step S311).

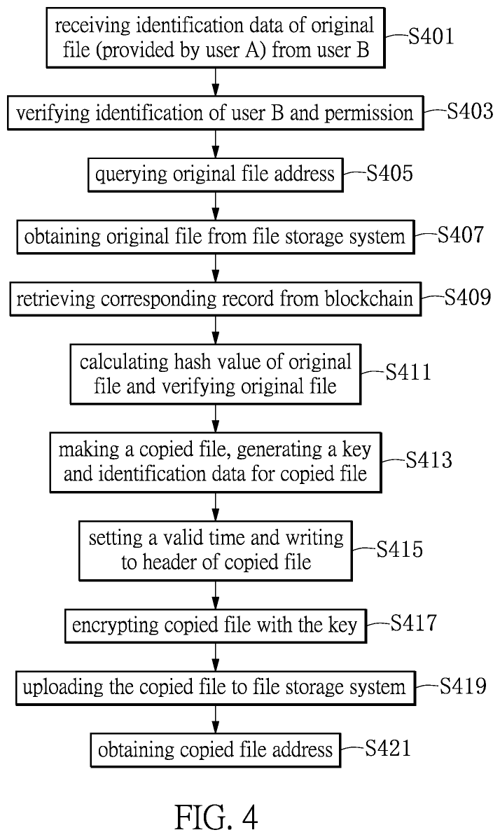

The user A completes a task of file preservation through the abovementioned steps. The file is then submitted to a file owner, which can be the user B mentioned in FIG. 4. For example, the file owner can be, but not limited to, a student awarded a degree, a person that obtains a license, or a sales company which manages product traceability.

In a second phase, the user B (e.g., the user B (102) of FIG. 1) acts as the file owner. The user B acquires the original file ID provided by the file server or any information that allows the file server to be able to retrieve the original file address from the user A. The user B can log on the file server for acquiring the original file provided by the user A after the identity of the user B is authenticated. The record of the blockchain can be used to verify the original file, and then a copy of the original file can be produced in the file server and shared with other users, such as the user C that is a file user. In particular, a valid time for accessing the copied file can be set in the copied file.

Reference is made to FIG. 4, which is a flowchart illustrating the validity management system providing a file and setting time validity in the second phase of the validity management system according to one embodiment of the present disclosure. According to the above-mentioned example, the user B obtains the information for retrieving the original file from the user A. The information can be an identification data of the original file and the identification data enabling the user to log on the file server, and the identification data can be an account and a password that enable the user B to be identified, so that the user B can retrieve the original file from the file server according to the information.

The file server receives an original file ID originally provided by the user A and submitted by the user B (step S401). The user B inputs information such as an account and a password for identity authentication via a user interface at the same time. The file server can therefore verify identity and permission of the user B (step S403). The file server queries a database or a lookup table to acquire an original file address based on the permission of the user B (step S405).

Next, the file server acquires the original file from the file storage system via a program procedure which is used to retrieve files (step S407). A decryption process may be necessary for acquiring the original file. A corresponding record in a blockchain can be retrieved according to the information originally created by the file server when the original file was uploaded (step S409). At this time, or when the original file is retrieved, an original file hash value is calculated for comparing with the record retrieved from the blockchain so as to verify the original file (step S411). Therefore, the original file retrieved from the file storage system is ensured to be not tampered with if the original file is verified based on the hash value. Further, the file server assists the user B to produce a copied file only if the original file is verified. The file server also simultaneously generates a key and a copied file ID (step S413), in which the copied file ID in the file server is used to identify the copied file.

At this time, the user B sets a time validity data for the copied file via a user interface provided by the file server. The time validity data can be a time period that is configured to be a valid time for accessing the copied file, or one or more time periods that are configured to be valid time for accessing the copied file. The time validity data is then written to a header or a metadata of the copied file (step S415).

The time validity regulates a period of time for accessing the copied file. The copied file may be unavailable to be accessed if the time has expired. The time validity can also be a schedule that regulates an available time for accessing the copied file, and a user can access the copied file based on the schedule.

A program procedure running in the file server encrypts the copied file by using a key that is proprietary for the copied file (step S417). The copied file is then uploaded to the file storage system (step S419). In the distributed file system, a distributed algorithm is performed on the copied file so as to form the data in compliance with the distributed file system so that the data is uploaded to the distributed file system. A copied file address can then be obtained from the file storage system (step S421).

In a third phase, the file server allows the user C (e.g., the user C (103) of FIG. 1) to obtain the copied file. In addition to obtaining the copied file from the file storage system according to the copied file address, the file server can verify the copied file based on the record of the blockchain. Further, the file server can also check the time validity of the copied file while obtaining the file and the file server can provide the copied file to the user C during the valid time period of the copied file.

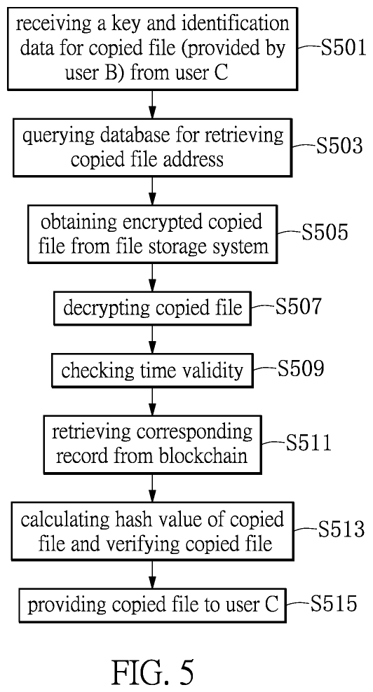

The process in the third phase can refer to a flowchart as shown in FIG. 5, which illustrates the validity management system verifying the time validity of the file and enabling a third party to retrieve the file. Before the process is performed, the above-mentioned user B, as the file owner, provides information (e.g., a key and/or a copied file ID) of the copied file with the time validity data to the user C.

The file server receives the key and/or the copied file ID provided by the user B and submitted by the user C via a user interface (step S501). The file server then obtains the copied file address by querying a database (step S503). Next, the file server obtains the encrypted copied file from the file storage system (step S505). The encrypted copied file can be decrypted by the key submitted by the user C (step S507). At this time, the file server accesses the copied file.

A program procedure running in the file server checks time validity data of a header or a metadata of the copied file (step S509). The file server performs a time validity verification procedure to check the time validity of the digital file based on a request for accessing the digital file. If the copied file complies with the time validity, the record of the blockchain is then obtained (step S511). A copied file hash value is then calculated and compared with the record of the blockchain in order to verify the copied file (step S513). When the copied file is verified, the copied file is provided to the user C (step S515).

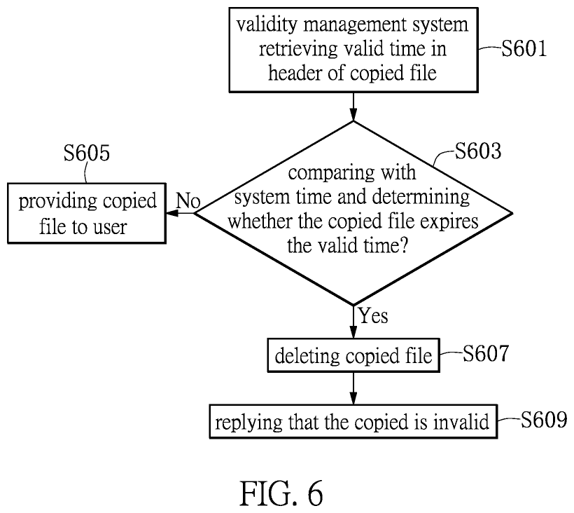

The time validity verification procedure can be referred to a flowchart shown in FIG. 6 according to one embodiment of the present disclosure. The time validity verification procedure is performed when the file server obtains the copied file from the file storage system according to the request for accessing the file, or when the file server checks time validity of the file stored in the file storage system periodically or according to an instruction. After the time validity is expired, the file storage system can actively delete the copied file.

In the flowchart shown in FIG. 6 according to one embodiment of the present disclosure, the program procedure running in the file server can retrieve the time validity data recorded in a header or metadata of the copied file based on a request issued by a user (step S601). By comparing with a system time, the time validity of copied file can be determined to be expired or not (step S603). If the time validity of the copied file is not expired, the copied file can be provided to the user since the copied file is still within a valid time period (step S605); otherwise, the copied file is deleted since the time validity of the copied file has expired (step S607). The file server then responds to the user that the file is invalid (step S609).

The above process performed by the validity management system allows a user to safely share a file with another user, and is able to add a time limit for accessing the file in addition to ensuring accuracy of the file.

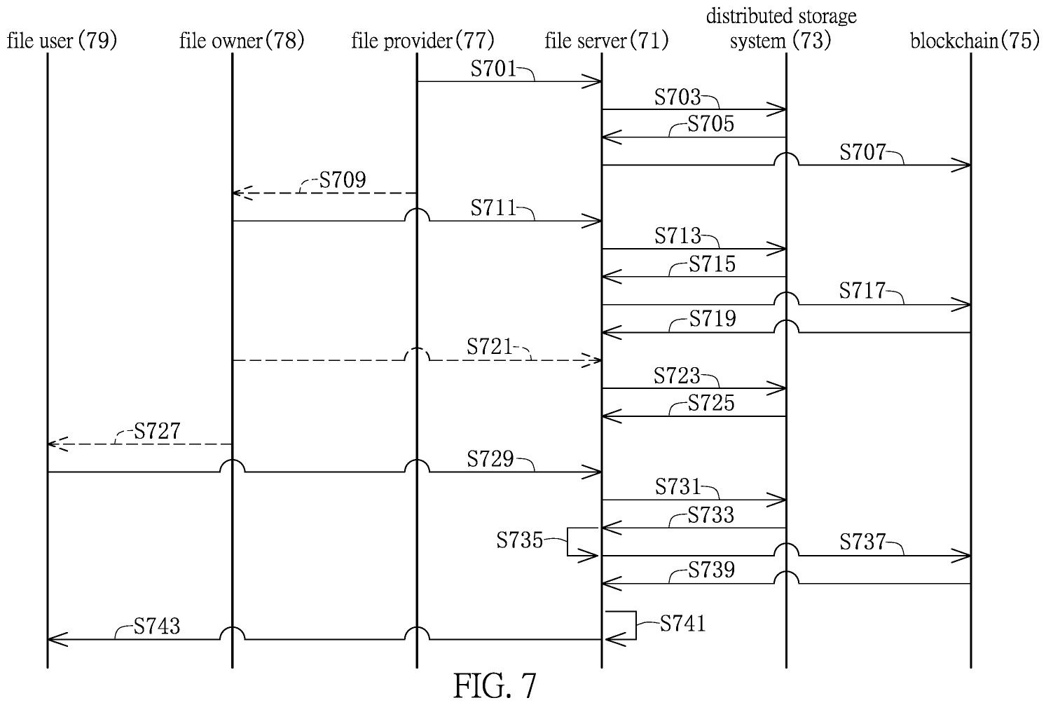

FIG. 7 is a flowchart illustrating a method for operating the validity management system for a digital file in one embodiment of the present disclosure. The process as shown in FIG. 7 is operated among a file server 71, a distributed storage system 73, and a blockchain 75. With preservation of a certificate (e.g., a diploma) as an example, the certificate is produced by a file provider 77 (e.g., a school), and the certificate is provided to a file owner 78 (e.g., a student). The validity management system is used to preserve the certificate and ensure accuracy of the certificate. The validity management system allows the file owner 78 to share the certificate with a file user 79. The file user 79 can be a school or an enterprise that is a party requiring the file owner 78 to prove the validity of the certificate. The file user 79 can therefore obtain a trustworthy certificate via the mechanism of the validity management system.

In the process shown in FIG. 7, the file provider 77 uploads a digital certificate to the file server 71, sets an original digital certificate ID and designates a file owner of the digital certificate (step S701). The digital certificate is then uploaded to a distributed storage system 73 (step S703). The file server 71 obtains an original digital certificate address (step S705) and uploads information such as the original digital certificate address, the original digital certificate ID, and an original digital certificate hash value that is calculated in the file server 71 to the blockchain 75 (step S707). After the original digital certificate is preserved, the file provider 77 can provide the information of the original digital certificate to the file owner 78 (step S709). The file owner 78 can then obtain the original digital certificate from the file server 71.

The file owner 78 requests for the original digital certificate based on the information of the original digital certificate (step S711). The file server 71 queries the original digital certificate address according to the information submitted by the file owner 78 (step S713). The file owner 78 can then download the original digital certificate from the distributed storage system 73 (step S715) and query a correlated record in the blockchain 75 (step S717). After the file owner 78 obtains the record relevant to the original digital certificate (step S719), the record can be used to verify the original digital certificate obtained from the distributed storage system 73.

Next, the file owner 78 can produce a copy of the original digital certificate in the file server 71. The file server 71 also generates a key for the copied digital certificate and an identification data of the copied digital certificate. Furthermore, a time validity data can be set for the copied digital certificate (step S721), and the key is then used to encrypt the copied digital certificate. The encrypted copied digital certificate is uploaded to the distributed storage system 73 (step S723), and the file owner 78 obtains a copied digital certificate address (step S725).

Afterwards, the file owner 78 can submit the key and/or the identification data of the copied digital certificate to the file user 79 (step S727). The file user 79 can request to obtain the copied digital certificate from the file server 71 when the file user 79 submits correlated information such as the key or the identification data of the copied digital certificate (step S729). The file server 71 queries the copied digital certificate address according to the information submitted by the file user 79 (step S731). The file server 71 obtains the copied digital certificate from the distributed storage system 73 (step S733). After decrypting the copied digital certificate with the key, the file server 71 verifies the time validity of the copied digital certificate (step S735). After the time validity of the copied digital certificate is verified, the file server 71 queries the relevant record in the blockchain 75 (step S737), and obtains the record (step S739). The record is then used to verify the copied digital certificate (step S741). After the verification is completed, the file user 79 can obtain the copied digital certificate within a valid time period (step S743).

In conclusion, according the above embodiments of the validity management system for a digital file and the method for operating a validity management system for a digital file, the file server is provided as a user interface for a user to access the digital file, and the mechanism of the validity management system allows the user to safely preserve the file, verify accuracy of the file via a blockchain, and configure for another person to access the file within a valid period of time. Therefore, the purposes of protecting personal data and file, and flexibly sharing the file to be protected can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for operating a validity management system for a digital file, the method being operated in a file server, and the method comprising:
receiving an original file ID submitted by a user;
querying a database in the file server for retrieving an original file address after identity and permission of the user are verified;
retrieving an original file from a file storage system according to the original file address;
obtaining a record corresponding to the original file from a blockchain according to the original file ID;
calculating, in the file server, an original file hash value with respect to the original file, and verifying the original file by comparing the original file hash value with a hash value recorded in the record obtained from the blockchain;
producing a copied file, generating a key, and creating a copied file ID after the original file is verified;
receiving a time validity data configured by the user for the copied file;
encrypting the copied file by using the key to add the time validity data into the copied file, uploading the encrypted copied file with the time validity data to the file storage system, and obtaining a copied file address; and
delivering the key and/or the copied file ID to the user.

2. The method according to claim 1, wherein a process for sharing the copied file with the time validity data with a file user includes:
receiving, in the file server, a request for obtaining the copied file from the file user, wherein the request includes the key and/or the copied file ID;
querying the database for retrieving the copied file address;
retrieving the encrypted copied file from the file storage system;
decrypting the encrypted copied file by using the key, so as to obtain the copied file;
checking the time validity data of the copied file, and calculating a copied file hash value with respect to the copied file if the copied file is valid;
retrieving the record corresponding to the original file from the blockchain, and verifying the copied file by comparing the copied file hash value with the hash value recorded in the record; and
providing the copied file to the file user after the copied file is verified.

3. The method according to claim 1, wherein the original file ID submitted by the user is provided by a file provider, and the original file ID is created when the original file is uploaded to the file storage system via the file server by the file provider.

4. The method according to claim 3, wherein a process of storing the original file provided by the file provider includes:
receiving, by the file server, the original file uploaded by the file provider;
setting, in the file server, the user as a file owner of the original file, and creating the original file ID;
calculating the original file hash value with respect to the original file;
encrypting the original file, uploading the encrypted original file to the file storage system, and obtaining the original file address;
uploading the original file hash value, the original file ID, and the original file address to the blockchain so as to form the record.

5. The method according to claim 4, wherein a process for sharing the copied file with the time validity data with a file user includes:
receiving, in the file server, a request for obtaining the copied file from the file user, wherein the request includes the key and/or the copied file ID;
querying the database for retrieving the copied file address;
retrieving the encrypted copied file from the file storage system;
decrypting the encrypted copied file by using the key, so as to obtain the copied file;
checking the time validity data of the copied file, and calculating a copied file hash value with respect to the copied file if the copied file is valid;
retrieving the record corresponding to the original file from the blockchain, and verifying the copied file by comparing the copied file hash value with the hash value recorded in the record; and
providing the copied file to the file user after the copied file is verified.

6. The method according to claim 1, wherein the time validity data configured by the user in the file server is written to a header or a metadata of the copied file.

7. The method according to claim 6, wherein a process for sharing the copied file with the time validity data with a file user includes:
receiving, in the file server, a request for obtaining the copied file from the file user, wherein the request includes the key and/or the copied file ID;
querying the database for retrieving the copied file address;
retrieving the encrypted copied file from the file storage system;
decrypting the encrypted copied file by using the key, so as to obtain the copied file;
checking the time validity data of the copied file, and calculating a copied file hash value with respect to the copied file if the copied file is valid;
retrieving the record corresponding to the original file from the blockchain, and verifying the copied file by comparing the copied file hash value with the hash value recorded in the record; and
providing the copied file to the file user after the copied file is verified.

8. The method according to claim 6, wherein the file server retrieves the copied file from the file storage system periodically or according to an instruction, and determines whether or not to provide the copied file according to the time validity data in the header or in the metadata.

9. The method according to claim 8, wherein the time validity data indicates a valid time or one or more available times for accessing the copied file.

10. The method according to claim 9, wherein a process for sharing the copied file with the time validity data with a file user includes:
receiving, in the file server, a request for obtaining the copied file from the file user, wherein the request includes the key and/or the copied file ID;
querying the database for retrieving the copied file address;
retrieving the encrypted copied file from the file storage system;
decrypting the encrypted copied file by using the key, so as to obtain the copied file;
checking the time validity data of the copied file, and calculating a copied file hash value with respect to the copied file if the copied file is valid;
retrieving the record corresponding to the original file from the blockchain, and verifying the copied file by comparing the copied file hash value with the hash value recorded in the record; and
providing the copied file to the file user after the copied file is verified.

11. A validity management system for a digital file, comprising:
a file server providing services including file preservation, verification, and time validity setting, and connecting with a file storage system and a blockchain; wherein, in the file server, a file provider provides an original file, creates an original file ID, calculates an original file hash value, uploads the original file to the file storage system, receives an original file address, uploads the original file hash value, the original file ID and the original file address to the blockchain, and forms a record;
wherein, when operating the validity management system for the digital file, a method for setting the time validity includes:
receiving the original file ID submitted by a user;
querying a database in the file server for retrieving the original file address after identity and permission of the user are verified;
retrieving the original file from the file storage system according to the original file address;
obtaining the record corresponding to the original file from the blockchain according to the original file ID;
calculating, in the file server, the original file hash value with respect to the original file, and verifying the original file by comparing the original file hash value with a hash value recorded in the record obtained from the blockchain;
producing a copied file, generating a key, and creating a copied file ID after the original file is verified;
receiving a time validity data configured by the user for the copied file;
encrypting the copied file by using the key to add the time validity data into the copied file, uploading the encrypted copied file with the time validity data to the file storage system, and obtaining a copied file address; and
delivering the key and/or the copied file ID to the user.

12. The validity management system according to claim 11, wherein a process for sharing the copied file with the time validity data with a file user includes:
receiving, in the file server, a request for obtaining the copied file from the file user, wherein the request includes the key and/or the copied file ID;
querying the database for retrieving the copied file address;
retrieving the encrypted copied file from the file storage system;
decrypting the encrypted copied file by using the key, so as to obtain the copied file;
checking the time validity data of the copied file, and calculating a copied file hash value with respect to the copied file if the copied file is valid;
retrieving the record corresponding to the original file from the blockchain, and verifying the copied file by comparing the copied file hash value with the hash value recorded in the record; and
providing the copied file to the file user after the copied file is verified.

13. The validity management system according to claim 11, wherein the file storage system is a distributed file system.

14. The validity management system according to claim 13, wherein a process for sharing the copied file with the time validity data with a file user includes:
receiving, in the file server, a request for obtaining the copied file from the file user, wherein the request includes the key and/or the copied file ID;
querying the database for retrieving the copied file address;
retrieving the encrypted copied file from the file storage system;
decrypting the encrypted copied file by using the key, so as to obtain the copied file;
checking the time validity data of the copied file, and calculating a copied file hash value with respect to the copied file if the copied file is valid;
retrieving the record corresponding to the original file from the blockchain, and verifying the copied file by comparing the copied file hash value with the hash value recorded in the record; and
providing the copied file to the file user after the copied file is verified.

15. The validity management system according to claim 11, wherein the time validity data configured by the user in the file server is written to a header or a metadata of the copied file.

16. The validity management system according to claim 15, wherein the file server retrieves the copied file from the file storage system periodically or according to an instruction, and determines whether or not to provide the copied file according to the time validity data in the header or in the metadata.

17. The validity management system according to claim 16, wherein the time validity data indicates a valid time or one or more available times for accessing the copied file.

18. The validity management system according to claim 17, wherein a process for sharing the copied file with the time validity data with a file user includes:
receiving, in the file server, a request for obtaining the copied file from the file user, wherein the request includes the key and/or the copied file ID;
querying the database for retrieving the copied file address;
retrieving the encrypted copied file from the file storage system;
decrypting the encrypted copied file by using the key, so as to obtain the copied file;
checking the time validity data of the copied file, and calculating a copied file hash value with respect to the copied file if the copied file is valid;
retrieving the record corresponding to the original file from the blockchain, and verifying the copied file by comparing the copied file hash value with the hash value recorded in the record; and
providing the copied file to the file user after the copied file is verified.
